(19) United States
(12) Patent Application Publication
(10) Pub. No.: US 2023/0095440 A1
(43) Pub. Date: Mar. 30, 2023

(54) Rotor Topology for High-Speed Electric Machines

(71) Applicant: Bayerische Motoren Werke Aktiengesellschaft, Muenchen (DE)

(72) Inventors: Norman BORCHARDT, Luebeck (DE); Robert SCHMIDT, Muenchen (DE)

(21) Appl. No.: 17/940,093

(22) Filed: Sep. 8, 2022

(30) Foreign Application Priority Data
Sep. 29, 2021 (DE) 10 2021 125 208.3

(51) Int. Cl. H02K 1/24

(52) U.S. Cl. CPC H02K 1/24

(57) ABSTRACT

A rotor core for a salient pole rotor of an electric machine for holding magnetic-field- generating components of the salient pole rotor is provided. The rotor core is formed with a salient pole topology and has a rotor yoke and salient poles which project radially from the rotor yoke and are formed in one piece with the rotor yoke. The salient poles each have a pole shaft for holding the magnetic-field-generating components and a pole shoe, and the rotor core has supporting web arrangements which are formed in one part with the salient poles and the rotor yoke and which, to counteract loads acting on the pole shoe during operation of the electric machine, connect pole shoe regions of the pole shoe that project laterally on the corresponding pole shaft to the rotor yoke.

### CROSS REFERENCE TO RELATED APPLICATION

This application claims priority under 35 U.S.C. § 119 from German Patent Application DE 10 2021 125 208.3, filed Sep. 29, 2021, the entire disclosure of which is herein expressly incorporated by reference.

### BACKGROUND AND SUMMARY

The invention relates to a rotor core for a salient pole rotor of an electric machine for holding magnetic-field-generating components of the salient pole rotor, the rotor core being formed with a salient pole topology and has a rotor yoke and salient poles which project radially from the rotor yoke and are formed in one piece with the rotor yoke. The salient poles each have a pole shaft for holding the magnetic-field-generating components and a pole shoe. The invention additionally relates to a salient pole rotor, an electric machine, and a motor vehicle.

Interest is currently focused on electric machines with salient pole geometry, called salient pole machines for short, which can be used for example as prime movers of electrified motor vehicles. The electric salient pole machines usually have a stationary stator with energizable stator windings and a salient pole rotor, which is mounted rotatably relative to the stator, with magnetic-field-generating components, for example energizable rotor windings and/or permanent magnets. The salient pole rotor has a rotor core with salient pole topology which carries the magnetic-field-generating components. The rotor core has a rotor yoke and salient poles projecting radially from the rotor yoke. The salient poles usually consist of a pole shaft or pole core projecting radially from the rotor yoke, with a rotor winding for example wound around the pole shaft or pole core, and a circle-segment-shaped pole shoe protruding tangentially from the pole shaft. Due to the geometry of the salient pole machine, a mechanical load acts in particular on the pole shoe during operation of the salient pole machine. The salient pole machine can therefore achieve only relatively low rotation speeds or peripheral speeds.

A rotor with multi-part salient poles is known from DE 10 2018 213 567 B3, for example. The salient poles each have a pole shaft formed in one part with the rotor yoke and pole shoe elements separate from the pole shaft. The pole shoe elements of two adjacent salient poles are connected via a reinforcement element in the form of a T-piece. The component formed from two pole shoe elements and one reinforcement element may be mechanically connected to the pole shafts and the rotor yoke by pushing together, for example by way of a dovetail joint. Such a rotor, however, is complex in respect of its assembly and has increased magnetic reluctances at its joints, in particular under rotation.

It is the object of the present invention to provide, for an electric machine, a rotor that can be manufactured easily, has contiguous electrical sheets, and additionally allows relatively high rotation.

This object is achieved by a rotor core, a salient pole rotor, an electric machine and a motor vehicle having the features according to the claimed invention.

A rotor core according to an embodiment of the invention for a salient pole rotor of an electric machine for holding magnetic-field-generating components of the salient pole rotor is formed with a salient pole topology. The rotor core for this purpose has a rotor yoke and salient poles, which project radially from the rotor yoke and are formed in one piece with the rotor yoke, the salient poles each having a pole shaft, for holding the magnetic-field-generating components, and a pole shoe. In addition, the rotor core has supporting web arrangements which are formed in one part with the salient poles and the rotor yoke. To counteract loads acting on the pole shoe during operation of the electric machine, the supporting web arrangements connect pole shoe regions of the pole shoe that project laterally from the corresponding pole shaft to the rotor yoke.

The invention additionally includes a salient pole rotor for an electric machine comprising magnetic-field-generating components and a rotor core according to an embodiment of the invention. The magnetic-field-generating components in particular comprise energizable rotor windings. An electric machine according to an embodiment of the invention for a motor vehicle comprises a stator and a salient pole rotor according to an embodiment of the invention mounted rotatably relative to the stator. The electrically excited machine is in particular an electrically excited electric synchronous machine and comprises a salient pole rotor according to an embodiment of the invention as an internal rotor.

The rotor core is formed in particular as a laminated core consisting of axially stacked and mechanically connected, one-piece electrical sheet laminations. The rotor core has the salient pole geometry. For this purpose, the rotor core comprises the rotor yoke, which for example is annular and which can be connected for conjoint rotation to a rotor shaft of the rotor for torque transfer. The salient poles are arranged projecting radially from the rotor yoke and are arranged in the peripheral direction, thus forming pole gaps spaced apart from one another. The salient poles each have a pole shaft or pole tooth, which in particular is parallel flanked and carries the magnetic-field-generating components. Each pole shaft has, arranged adjacently to it, a pole shoe, which in particular is circle-segment-shaped and which holds the magnetic-field-generating components on the relevant pole shaft by taking up the centrifugal force acting on the magnetic-field-generating components. For this purpose, pole shoe regions of the pole shoe protrude on both sides from the pole shaft in the peripheral direction.

Under load, that is to say during rotation of the salient pole rotor during operation of the electric salient pole machine, mechanical stresses occur in the salient poles and limit a rotational speed or peripheral speed of the salient pole rotor. These mechanical stresses result on the one hand from the rotating mass of the magnetic-field-generating components and on the other hand from the rotating dead weight of the salient pole. In order to be able to allow high rotational speeds, the supporting web arrangements are provided, which at least reduce the mechanical stresses in the salient poles. In particular, the pole shoes are exposed to a load since the magnetic-field-generating components exert a pressure on the pole shoe on account of the centrifugal forces acting on the magnetic-field-generating components during rotation of the salient pole rotor.

In order to prevent a failure of the pole shoe, the supporting web arrangements are mechanically connected to the rotor yoke and the pole shoes. For this purpose, the supporting web arrangements are arranged in the pole gaps and are formed in one part with the rotor yoke and the pole shoe regions projecting laterally beyond the pole shaft. For this purpose, the electrical sheet laminations, which are stacked in the axial direction, are formed in one piece. The electrical sheet laminations are manufactured here via a separation process, for example by punching. The rotor core comprising the supporting web arrangements is created by axially stacking these electrical sheet laminations. The supporting web arrangements form tie rods, which extend radially between the rotor yoke and the pole shoe regions. The supporting web arrangements provide a radially acting counter force, that is to say a radial force, which counteracts the centrifugal force, and thus stabilize the pole shoe regions.

By way of such a rotor core, a high-speed electric machine can be provided which in addition is particularly easily installed.

In the case of a salient pole rotor in which the magnetic-field-generating components have rotor windings arranged around the pole shafts, the supporting web arrangements are additionally preferably configured to fix the rotor windings by clamping the rotor windings between the relevant pole shaft and the supporting web arrangement on the associated pole shaft. The salient pole rotor is preferably formed free from potting compound. The supporting web arrangements can thus press the rotor windings against the relevant pole shaft, so that the rotor windings are clamped between the supporting web arrangements and the pole shaft flanks. It is thus possible advantageously to dispense with a potting compound with which rotors are usually potted in order to fix the rotor windings.

It has proven to be advantageous if a supporting web arrangement is arranged in each of the pole gaps formed between two adjacent salient poles and mechanically connects the pole shoe regions of the adjacent salient poles to the rotor yoke. In particular, the supporting web arrangements are Y-shaped or V-shaped. The rotor core thus has a number of supporting web arrangements corresponding to the number of salient poles, so that pole shoe regions, facing one another, of two adjacent salient poles are mechanically connected to the rotor yoke by a supporting web arrangement. A supporting web arrangement is thus arranged in each pole gap. For example, for this purpose, the supporting web arrangements may each have two supporting webs arranged in a V shape, an apex of the supporting webs arranged in a V shape being connected to the rotor yoke directly or, with formation of a Y shape, via a further radial supporting web.

The invention additionally includes a motor vehicle comprising at least one electric machine according to an embodiment of the invention. The motor vehicle is in particular an electrified motor vehicle and comprises the at least one electric machine as prime mover.

The embodiments presented in relation to the rotor core according to embodiments of the invention and resulting advantages apply correspondingly to the salient pole rotor according to embodiments of the invention, to the electric machine according to the invention, and to the motor vehicle according to embodiments of the invention.

Further features of the invention will become clear from the claims, the figure and the figure description. The features and feature combinations presented above in the description as well as the features and feature combinations presented hereinafter in the figure description and/or shown separately in the figure can be used not only in the combination specified in each case, but also in other combinations or in isolation.

The invention will now be explained in greater detail with reference to an exemplary embodiment and with reference to the drawing.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 shows a partial cross-sectional illustration of components of an electric machine.

### DETAILED DESCRIPTION OF THE DRAWING

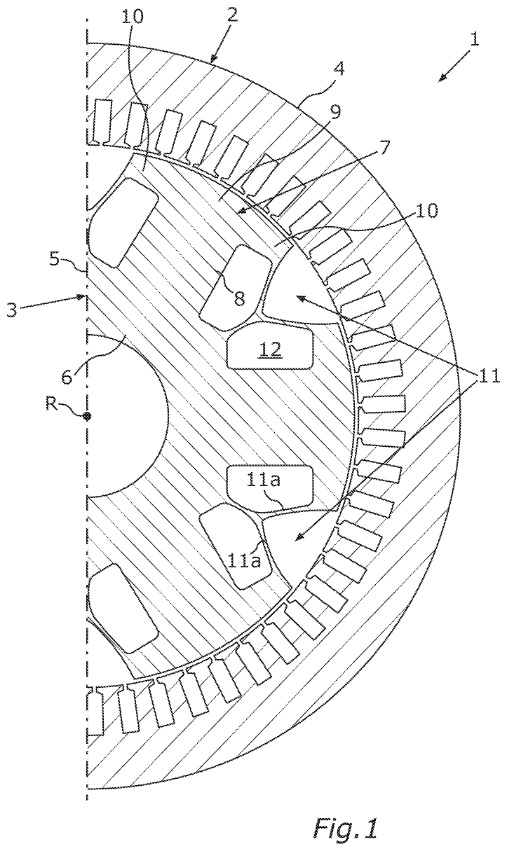

The electric machine 1 shown in FIG. 1 can be used as a prime mover for an electrified motor vehicle and comprises a stator 2 and a salient pole rotor 3 which is mounted rotatably in relation to the stator 2 about a rotation axis R. The stator 2 comprises a stator core 4 with energizable stator windings, not shown here. The salient pole rotor 3 has a rotor core 5 with magnetic-field-generating components, not shown here, in particular energizable rotor windings.

The rotor core 5 has a rotor yoke 6 and salient poles 7. The salient poles 7 have a pole shaft 8, which for example carries a rotor winding, and a pole shoe 9. Pole shoe regions 10 of the pole shoe 9 protrude here laterally from the pole shaft 8 in the circumferential direction. To stabilize the salient poles 7, the rotor core 5 additionally has supporting web arrangements 11, and here a supporting web arrangement 11 is arranged in each pole gap 12 between two adjacent salient poles 7 and mechanically connects the pole shoe regions 10, facing one another, of the adjacent salient poles 7 to the rotor yoke 6. The supporting web arrangements 11 are formed in one piece with the salient poles 7 and the rotor yoke 6, so that the rotor core 5 is formed in one piece, at least in the cross-sectional plane perpendicularly to the rotation axis R.

Here, a supporting web arrangement 11 has three supporting webs 11a arranged in a Y shape, with two supporting webs 11a being arranged in a V shape and connected to the pole shoe regions 10 and an apex of the V-shaped arrangement being connected to a supporting web 11a connected to the rotor yoke 6. This supporting web arrangement 11 provides a radial force which is effective oppositely to the centrifugal force acting during operation of the salient pole rotor 3 and by way of which the salient poles 7 are stabilized, in particular in the region of the pole shoe 9. The electric machine 1 can thus provide high rotational speeds.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rotor core for a salient pole rotor of an electric machine for holding magnetic-field-generating components of the salient pole rotor, the rotor core being formed with a salient pole topology, the rotor core comprising:
a rotor yoke; and
salient poles which project radially from the rotor yoke and are formed in one piece with the rotor yoke, wherein:
the salient poles each have a pole shaft for holding the magnetic-field-generating components and a pole shoe, and
the rotor core has supporting web arrangements which are formed in one part with the salient poles and the rotor yoke and which, to counteract loads acting on the pole shoe during operation of the electric machine, connect pole shoe regions of the pole shoe that project laterally from the corresponding pole shaft to the rotor yoke.

2. The rotor core according to claim 1, wherein a respective supporting web arrangement is arranged in each of pole gaps formed between two adjacent salient poles of the supporting web arrangements and connects the pole shoe regions of the adjacent salient poles mechanically to the rotor yoke.

3. The rotor core according to claim 2, wherein the supporting web arrangements are Y-shaped or V-shaped.

4. The rotor core according to claim 1, wherein the rotor core consists of axially stacked, mechanically connected, one-piece electrical sheet laminations.

5. The rotor core according to claim 1, wherein the supporting web arrangements are configured to fix magnetic-field-generating components in a form of rotor windings by clamping the rotor windings between a respective pole shaft and a respective supporting web arrangement on the respective pole shaft.

6. A salient pole rotor for an electric machine, the salient pole rotor comprising:
magnetic-field-generating components; and
the rotor core according to claim 1.

7. The salient pole rotor according to claim 6, wherein the magnetic-field-generating components have energizable rotor windings.

8. An electric machine for a motor vehicle, the electric machine comprising:
a stator; and
a salient pole rotor according to claim 6, wherein the salient pole rotor is mounted rotatably in relation to the stator.

9. A motor vehicle comprising at least one electric machine according to claim 8.
